(19) United States
(12) Patent Application Publication
(10) Pub. No.: US 2011/0223920 A1
(43) Pub. Date: Sep. 15, 2011

(54) WIRELESS COMMUNICATION SYSTEM AND METHOD FOR ASSIGNING PHYSICAL-LAYER CELL IDENTITIES OF BASE STATIONS IN WIRELESS COMMUNICATION SYSTEM

(76) Inventor: Xiaojie WANG, Yokohama (JP)

(21) Appl. No.: 13/020,136

(22) Filed: Feb. 3, 2011

(30) Foreign Application Priority Data
Mar. 12, 2010 (JP) 2010-055287

(51) Int. Cl. H04W 36/06

(52) U.S. Cl. 455/444

(57) ABSTRACT

While dividing a limited number of physical-layer cell identities (PCIDs) into a group of PCIDs to be added to macro-cell base stations and another group of PCIDs added to femtocell base stations, a center machine associating with a femtocell base station that applies for PCID addition refers to a table storing therein area information of a plurality of macrocell base stations and femtocell base stations within a wireless communication system to thereby identify the area of a message-transmitted femtocell base station and PCIDs being presently used in this area, selects an unused PCID in this area, and assigns it to the PCID addition-requesting femtocell base station. With such arrangement, while maximally leveraging the limited number of PCIDs in the wireless communication system, PCID setup is automatically performed in such a way as to prevent the PCID from becoming the same as a PCID of its neighboring base station.

### INCORPORATION BY REFERENCE

The present application claims priority from Japanese application JP 2010-055287 filed on Mar. 12, 2010, the content of which is hereby incorporated by reference into this application.

### BACKGROUND OF THE INVENTION

The present invention relates generally to wireless telecommunications systems and base station parameter setting methodology for use therein. More particularly, this invention relates to a method and apparatus for assigning physical-layer cell identities to base stations.

Owing to advances in wireless communication technology, it becomes possible to provide access to the Internet using cellular telephones, resulting such cellular phones becoming more frequently used not only in voice communications but also in various daily life scenes. In addition, due to improvement in performance of mobile phones and also a noticeable increase in cell phone-oriented contents on the Internet, the data communication traffic is also increasing dramatically. Furthermore, provision of data exclusive-use wireless communication lines results in debut of not only cell phones but also data communication-dedicated terminals and personal computers (PCs) of the type having built-in communication terminal functionalities (hereinafter, these devices will collectively be called the mobile terminals).

Wireless communications are communications using radio waves having the nature of propagating in atmospheric space. As radio waves are absorbable by architectural materials and reflectable thereat, such waves can decrease in electrical power in specific spaces, such as indoor environments. It is noted that prior known wireless communications systems are typically designed so that macro-cell base stations (large-output base station apparatus or equipment with wide coverage area) are deployed as intra-system base stations, each of which covers a land area with its radius of several kilometers. Unfortunately, this poses a problem as to the lack of an ability to achieve enhanced throughputs in a downstream line or “downlink” for use in communications of from a base station to a mobile terminal, also called the forward link in some cases, due to deterioration of line/channel quality within indoor spaces. Also note that on an uplink for communication of from the mobile terminal to the base station, also called the reverse link, it is required for the mobile terminal to communicate with the base station at increased transmission power in view of the fact that the terminal sends forth its radio wave over-the-air toward the base station which is spaced far therefrom by several kilometers. This raises a problem as to an increase in electrical power consumption of the mobile terminal.

Currently, in light of the fact that the Internet access by means of mobile terminals becomes popularized and that mobile terminals have become Internet access terminals comparable to PCs, an increasing number of users give access to the Internet using his or her mobile terminal even at home during nighttime hours. In traditional wireless communication systems, it is difficult as stated supra to maintain an excellent radio-wave environment in the indoor space while letting it cover up to every corner thereof. One of noteworthy solutions to avoiding this difficulty is to implement a radio communication system employing, in addition to macrocell base stations, downsized “femtocell” base stations (i.e., small-output cellular base stations having a coverage area with its radius of about several tens of meters at a maximum), which are deployed for installation within indoor spaces of private residences, such as houses, buildings, etc. By installing and using a femtocell base station while connecting it to a fiber-optic broadband communication line railed up to the private residence or else, it becomes possible, even in indoor spaces suffering from difficulty in arrival of the radio wave from a macrocell base station, to improve the throughput to thereby enable a user(s) to perform the intended browsing and downloading of videos comfortably. Another advantage lies in a decrease in transmission power owing to the mobile terminal's access to the femtocell base station located in close proximity thereto, while at the same time enabling achievement of communications in excellent radiowave environments for both of the uplink and downlink.

Femtocell base stations are designed to decrease in size and price in order to promote popularization of home-use applications so that there is no need for any exclusive installation sites. However, when installing a femtocell base station, it is inevitable to precisely determine positional information of an installation site in a similar way to general public-use base stations. It is also required to prevent mutual interference between a macrocell base station and its neighboring or adjacent femtocell base station(s). In view of these conditions, the base station installation generally requires an engineering work for setup and equipment adjustment to be done by an expert vendor worker or technician.

### SUMMARY OF INVENTION

In the long term evolution (LTE) which is regarded as the 3.9-generation wireless communication system, specific identifiers, i.e., physical-layer cell identity (PCID) and global cell identity (GCID), are defined in order to avoid interference between base stations operating in a system and also to distinguish each of intra-system base stations from the others.

Here, the PCID and GCID will be set forth in greater detail.

The PCID is a diffusion code pursuant to LTE standards. Based on the PCID, a signal of each base station (or “cell”) is distinguished, followed by execution of coding and decoding of the signal to be sent and received between a mobile terminal and a base station. If it has no defined PCID, communications between the mobile terminal and the base station are no longer performable. More specifically, the PCID is the name of a base station for the communication use. This kind of ID is also called the physical-layer cell identity (PCID) in view of the fact that it is used in a physical layer of communication protocols. Every base station has a single PCID without exception. Currently the 3rd Generation Partnership Project (3GPP) LTE specification defines up to 504 unique PCIDs (see Chapter 6.11 of 3GPP standardization document titled “3GPP TS 36.211 V9.0.0”). These PCIDs are divided into 168 groups, with three PCIDs of from “0” to “2” being defined per group.

The GCID is an acronym of the global cell identity. This is called the cell global identification (GCI) in the above-cited 3GPP standardization document titled “3GPP TS 36.211 V9.0.0, Chapter 6.11”. In this patent application, the term “GCID” will be used for explanations given therein. The GCID is an identifier of a base station. Each base station has its own GCID. The GCID is a value which is kept unique within a global range. Any two of GCIDs of respective base stations, including base stations of different operators, do not overlap each other in any event.

As previously stated, the 3GPP LTE standardization defines only a limited number—i.e., 504—of PCIDs. These 504 PCIDs must be allocated to and used in macrocell base stations and femtocell base stations that are expected to become widely used in homes in near future. In reality, a total number of macrocell base stations and femtocell base stations is already in excess of the PCID number. Consequently, neighboring base stations around a certain base station are designed to use different PCIDs in principle and, if this is not attainable, use PCIDs which are the same as those of distant base stations. However, if femtocell base stations rapidly come into wide use in near future, it will possibly happen that several tens or hundreds of femtocell base stations are provided within the radiowave coverage area of a macrocell base station.

In a case where base stations adjacent to each other have the same PCID, it is no longer possible for a mobile terminal to distinguish these adjacent base stations from each other; so, its communication functionality is lost. To avoid this, it is a must to adequately allocate the PCIDs of base stations including femtocell base stations in such a way as to prevent the PCID of a base station from becoming the same as PCIDs of its neighboring base stations. It is also noted that in view of the fact that femtocell base stations are free from the restriction as to installation locations and will be put in homes, the execution of an engineering work for equipment setup/configuration every time a femtocell base station is deployed would result in an increase in manpower for both of the expert vendor worker and user. Additionally, it is also occurrable that the once-deployed femtocell base station is moved by the user to another location. If such installation and movement or “migration” events increase in number significantly, the human workload needed therefor becomes unignorable. Accordingly, it has been desired to provide a technique or scheme capable of executing the PCID setup procedure in an automated way.

WO2009/158519 A1 discloses therein a method for enhancing the diffusion code generation means to thereby support an increased number—1024 or more—of diffusion codes in order to prevent occurrence of PCID overlapping or “double use” otherwise occurring due to the loss of the uniqueness of PCID as a result of addition of a home-use evolved node B (eNB), such as a femtocell base station. The technique as taught by this patent literature makes it inevitable to perform large-scale processing which goes beyond LTE standards.

This invention has been made in order to solve the above-noted problems, and its object is to provide a technique for enabling automatic setup of PCIDs of base stations in a wireless communication system in such a manner as to maximally leverage a limited number of PCIDs while preventing a PCID of a base station from becoming the same as PCID of its neighboring base station.

A wireless communication system incorporating the principles of this invention is arranged to include a plurality of macrocell base stations, a plurality of femtocell base stations and a center machine which is operatively connected thereto via a network, wherein each of the macrocell base stations and femtocell base stations is managed while being added a global cell identity (GOD) and a physical-layer cell identity (PCID).

PCIDs to be added to femtocell base stations are distinguished in advance from those PCIDs to be added to macrocell base stations. The center machine has a first table which stores therein the area information of a plurality of macrocell base stations and femtocell base stations in the wireless communication system, GCIDs and PCIDs, and a second table storing therein the information as to usage situations of a limited number of PCIDs within the wireless communication system.

A femtocell base station which attempts to apply for the addition of a PCID transmits to the center machine a PCID addition application message that contains therein a GCID of a macrocell base station near or around the femtocell base station, a GCID of the femtocell base station, and a GCID of a radio wave-receivable neighboring femtocell base station, if any.

Upon receipt of the PCID addition application message, the center machine refers to the first table to thereby identify an area of the message-transmitted femtocell base station and one or more PCIDs being presently used in this area, and selects an unused PCID in such area, and then sends it to the femtocell base station.

In addition, in cases where the unused PCID is not found within the area, the center machine refers to the second table to thereby select a PCID which is relatively low in frequency of usage, and then sends it to the femtocell base station.

In accordance with this invention, in the wireless communication system, it is possible to set up automatically the PCID of a base station by maximally utilizing the limited number of PCIDs while preventing it from becoming the same as the PCID of its neighboring base station. Base stations with the same PCID are no longer placed in close proximity to each other; thus, it is possible to guarantee more stable communication quality at increased speeds.

By automatically setting up the PCID, it becomes possible for a user to deploy and install a femtocell base station by himself, resulting in an increase in usability and convenience. In a case where an expert vendor technician installs the femtocell base station, the PCID setup procedure can be automated, which leads to an increase in efficiency of installation work operation.

Other objects, features and advantages of the invention will become apparent from the following description of the embodiments of the invention taken in conjunction with the accompanying drawings.

### BRIEF DESCRIPTION OF DRAWINGS

FIG. 1 is a diagram showing an exemplary configuration of a wireless communication system.

FIG. 2 is a diagram showing a positional relationship of a macro-cell base station and femtocell base stations for explanation of one example of coverage ranges of base stations.

FIG. 3 is a diagram showing an assignment example of PCID spaces in one embodiment of this invention.

FIG. 4 is a sequence diagram for explanation of a processing content of automatic PCID setup in one embodiment of this invention.

FIG. 5 is a flow chart for explanation of a processing content in a setup mode of a femtocell base station.

FIG. 6 is a flowchart for explanation of a processing content in a service mode of the femtocell base station.

FIG. 7 is a flowchart for explanation of a processing content of periodical GCID transmission processing at a base station.

FIG. 8 is a flowchart for explanation of a processing content of PCID addition processing at a center machine.

FIG. 9 is a flowchart for explanation of a content of processing to be executed by the center machine for eliminating interference between femtocell base stations.

FIG. 10 is a diagram showing an exemplary database configuration of the center machine.

FIG. 11 is a diagram showing state transitions of a femtocell base station.

FIG. 12 shows a sequence for eliminating mutual interference between femtocell base stations.

### DETAILED DESCRIPTION OF THE EMBODIMENTS

Currently preferred embodiments of this invention will be described in detail below.

First, an explanation will be given of a configuration of a wireless communication system embodying the invention.

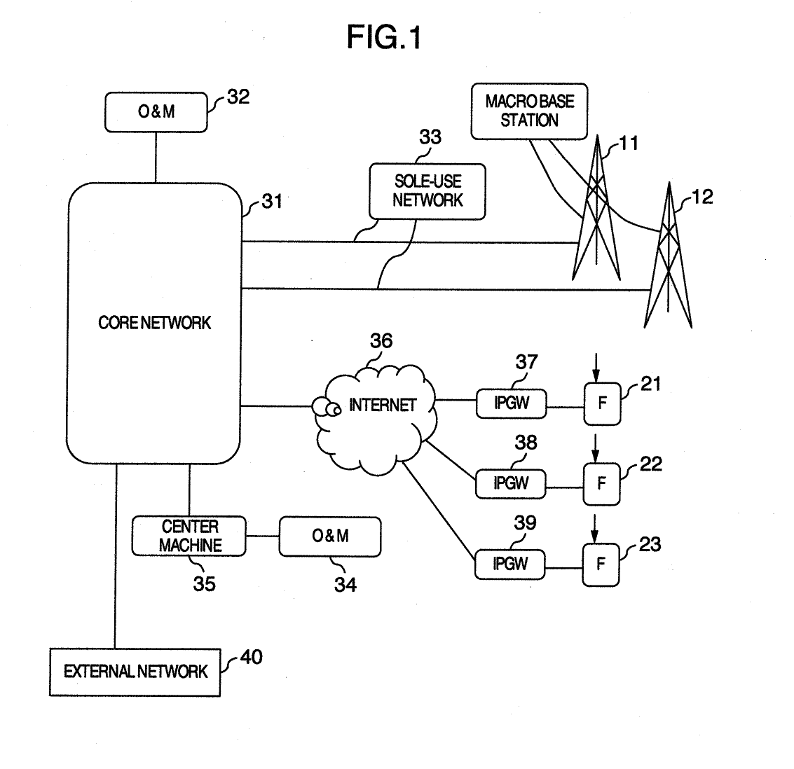

FIG. 1 is a diagram showing a configuration example of the wireless communication system. In FIG. 1, a macro-cell base station 11, 12 is operatively connected via an exclusive-use network 33 to a core network 31 and a center machine 35 which is linked to the core network. Femtocell base stations 21-23 are connected via Internet Protocol (IP) gateways 37-39 and the Internet 36 to the core network 31 and the center machine 35 linked to the core network 31. The femtocell base station 21 is a cellular base station to be added whereas the femtocell base stations 22 and 23 are set as the currently existing base stations. The core network 31 is further connected to an external network 40. An operation and maintenance (O&M) device 32 is an apparatus or equipment which performs operations and maintenance of the core network 31. This O&M device 34 is connected to the center machine 35, and has femtocell base station operation/maintenance and information input functionalities.

In this embodiment, an explanation will be given below under an assumption that the femtocell base station 21 is a femtocell base station which is newly deployed and installed in a residential space or in an office or the like, whereas the femtocell base stations 22-23 are the currently existing femtocell base stations.

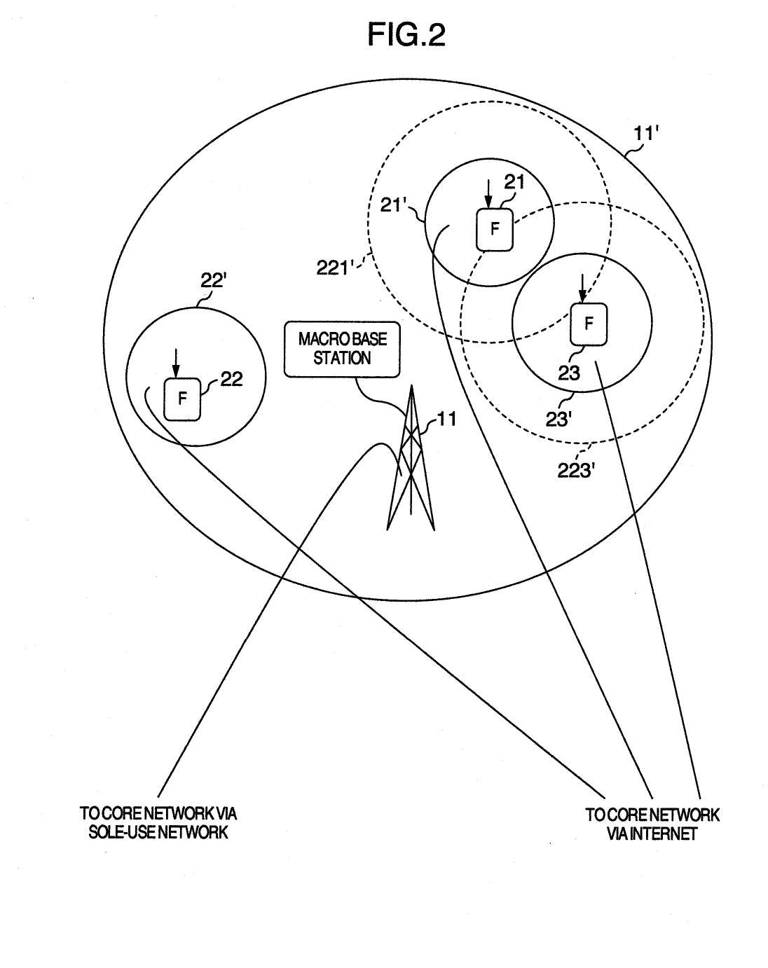

FIG. 2 is a diagram which shows the positional relationship of a macrocell base station and its associated femtocell base stations for explanation of one example of coverage areas of these base stations.

FIG. 2 shows the positional relationship of the macrocell base station 11 and the femtocell base stations 21, 22 and 23 shown in FIG. 1 and one example of the coverage ranges of respective base stations.

In FIG. 2, the coverage range of the macrocell base station 11 is indicated by reference numeral 11′. The coverage ranges of three femtocell base stations 21-23 are denoted by 21′, 22′ and 23′, respectively. In this embodiment, the femtocell base stations 22 and 23 are the existing femtocell base stations whereas the femtocell base station 21 is an additionally deployed femtocell base station. Numeral 223′ indicates a coverage range of the femtocell base station 23 prior to additional installation of the femtocell base station 21.

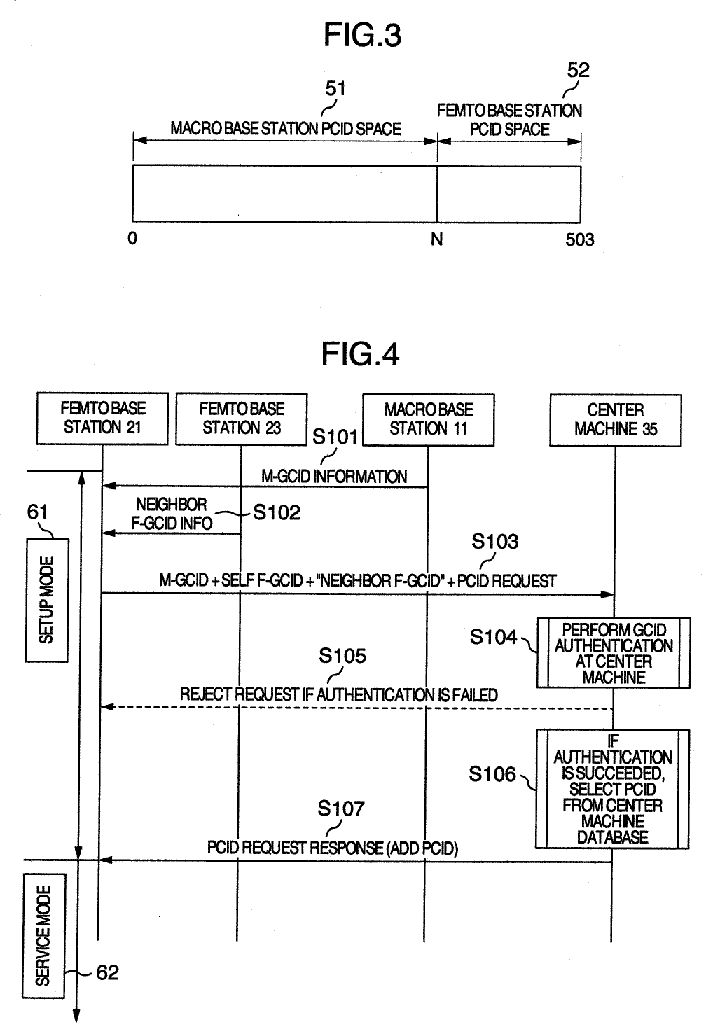

Shown in FIG. 3 is an assignment example of PCID spaces in one embodiment of this invention.

As previously stated, in long term evolution (LTE) systems compliant to the 3rd Generation Partnership Project (3GPP) standardization, the number of PCIDs is defined to be 504. In this embodiment, the base stations are divided into two kinds, i.e., macrocell base stations and femtocell base stations. In order to prevent the mutual interference stated above, a method is presented in this embodiment for using PCIDs while dividing them into two groups as will be stated below. More specifically, an array of 504 PCIDs of from 0 up to 503 is divided into two groups: a macrocell base station PCID space 51 and a femtocell base station PCID space 52. Letting the macrocell base station PCID space 51 which is used by macrocell base stations be a span extending from 0 to N, the femtocell base station PCID space 52 that can be used by femtocell base stations becomes a span of from N+1 to 503. With this arrangement, the PCIDs to be used by femtocell base stations and the PCIDs used by macrocell base stations are separated, resulting in overlap or “double use” being eliminated. Thus, mutual interference occurrable due to the use of the same PCID by different base stations is avoided almost perfectly.

Next, an explanation will be given of an automatic PCID setup method.

FIG. 4 is a sequence diagram for explanation of the processing content of an automated PCID setup procedure in one embodiment of this invention.

In a state before entering the sequence diagram of FIG. 4, a femtocell base station first goes into a self-diagnostic mode in responding to electrical power activation, and then performs checkup of its respective functional blocks. Thereafter, it transits to a setup mode. Shown in FIG. 4 is a sequence after the newly added femtocell base station 21 has transited to the setup mode after activation of electric power.

The femtocell base station 21 being presently set in the state of setup mode 61 searches for a signal which is sent from the macrocell base station 11 that is located therearound in a similar manner to usual communication terminals. Upon detection of a signal being sent from the circumjacent macrocell base station 11, the femtocell base station 21 starts synchronous processing for trying to receive information being transmitted by the macrocell base station 11. The information to be provided by the macrocell base station 11 contains the information as to macrocell base station's GCID, also known as macro-GCID or “M-GCID” (as indicated by S101 in FIG. 4).

The femtocell base station 21 also searches for a signal to be sent from its circumjacent femtocell base station. The femtocell base station 21 detects a signal being transmitted from the femtocell base station 23. The femtocell base station 21 gets into synchronous processing for synchronization with the femtocell base station 23 and attempts to receive the information being provided by the femtocell base station 23. The information to be sent by the femtocell base station 23 contains the information concerning neighboring femtocell base station GCID(neighbor “femto-GCID” or “F-GCID”) (as shown by S102 in FIG. 4). A specific F-GCID is set in the femtocell base station. This F-GCID has a value that is unique within a global range.

The femtocell base station 21 sends forth toward the center machine 35 via the core network 31 a PCID request command, which contains therein the M-GCID information that was received at S101 and the neighbor F-GCID information received at S102 along with the F-GCID of the femtocell base station 21 (at S103).

The center machine 35 being linked to the network receives the PCID request command as sent from the femtocell base station 21 and first performs authentication to determine whether or not the GCID (i.e., M-GCID and F-GCID) contained in the PCID request is the GCID of the core network 31 to which the center machine 35 is linked. In a case where it is not the one of the network 31, the center machine 35 judges that the authentication is in fail and rejects a present registration application based on the PCID request command.

In case the GCID (M-GCID and F-GCID) contained in the PCID request is the GCID of the core network 31 to which the center machine 35 is linked and thus the center machine 35 succeeds the authentication, the center machine 35 searches its database to select from its search result a PCID with reduced occurrability of interference (at step S104). Regarding a method of selecting this PCID, a detailed explanation will be given later with reference to FIG. 8. The center machine 35 registers the selected PCID in the database. In addition, the center machine 35 transmits a PCID request response command containing therein the selected PCID to the femtocell base station 21 which has sent the PCID request command (at S105). After having received the PCID from the center machine 35, the femtocell base station 21 stores the acquired PCID in its memory. Then, the base station changes its operation mode to a service mode.

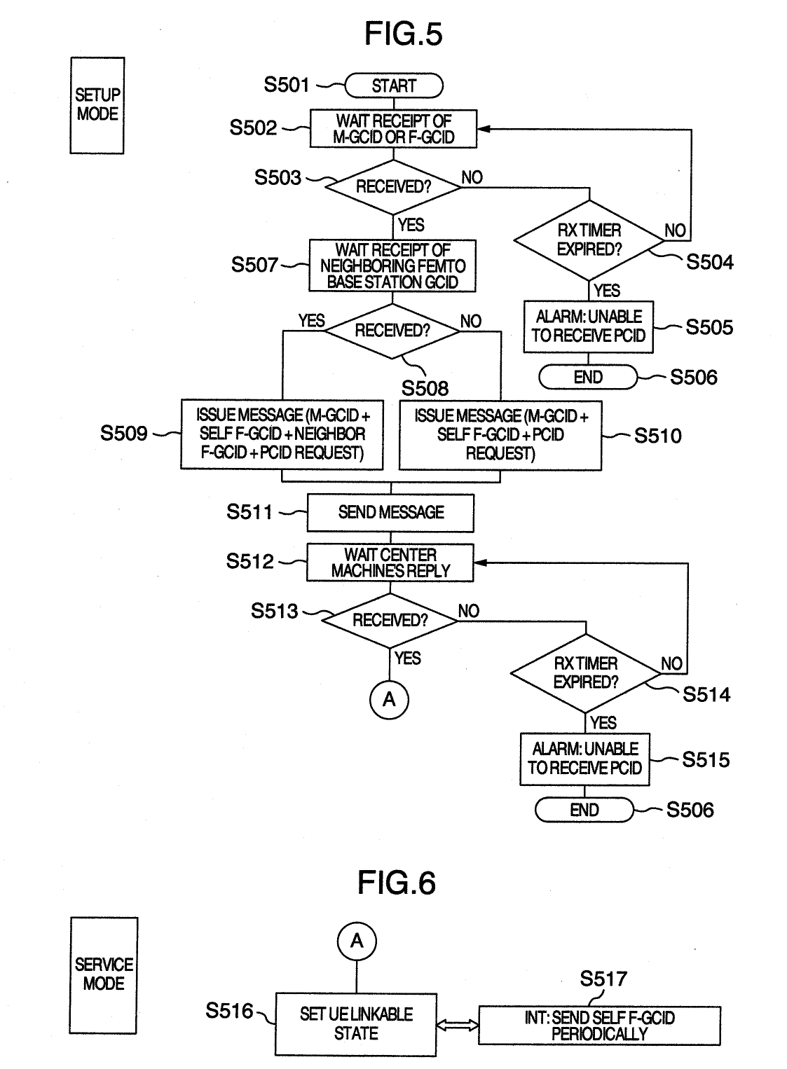

FIG. 5 is a flow chart for explanation of the content of processing in an operation mode for setup of a femtocell base station.

After start-up of the processing in the setup mode (at step S501), the femtocell base station first renders a signal reception timer operative and waits for reception of M-GCID or F-GCID (at S502). The femtocell base station determines whether the M-GCID has already been received (S503). In case no M-GCID is received, when the timer does not yet indicate the end of a prespecified time interval, the procedure returns to the step S502 which continues waiting for reception of M-GCID or F-GCID. When the timer indicates the end of time interval (S504), the base station generates and issues an alarm noticing that any PCID cannot be received (S505), followed by completion of the setup mode (S506).

In case M-GCID is received, the femtocell base station tries to receive the F-GCID of its neighboring femtocell base station (i.e., neighbor F-GCID) (at step S507 of FIG. 5). When this F-GCID can be received, the femtocell base station generates a PCID application message (M-GCID+F-GCID+“neighbor F-GCID”+PCID request) (at step S509). If it is unable to receive the neighbor F-GCID, the base station generates a PCID application message (M-GCID+F-GCID+PCID request) (at S510). Then, the base station sends the PCID application message to the center machine (S511). After having sent this message, the base station activates its signal reception timer and waits for arrival of a PCID request response from the center machine (S512). When the reception timer reaches the end of a time interval (S514), the base station issues an alarm prompting the lack of PCID receivability (S515), and then quits the setup mode (S506). When the PCID request response from the center machine is received and a PCID is added (S513), the base station quits the setup mode, and then transits to the service mode (at connector node “A” in FIG. 5).

An explanation will next be given of the processing content in the service mode of the femtocell base station.

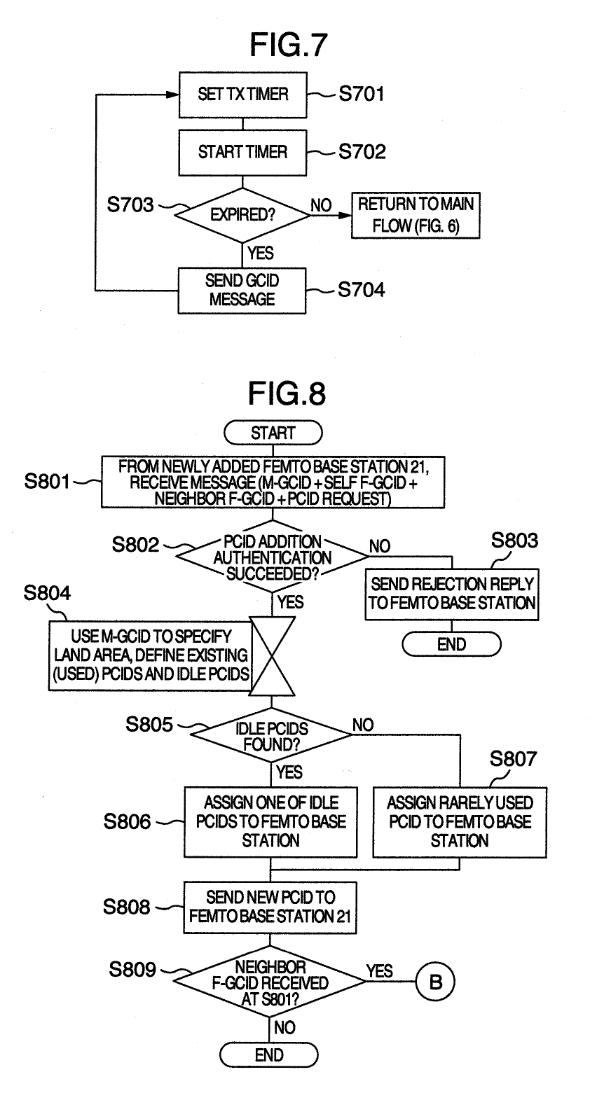

FIG. 6 is a flowchart for explanation of the processing content in the service mode of the femtocell base station.

It shows a process flow which follows the node “A” of FIG. 5.

When the femtocell base station goes into the service mode and starts its service, this base station is set in a terminal-connectable state (at step S516). Then, the base station performs periodical transmission of its F-PCID as an interruption operation thereof (at S517).

An explanation will next be given of periodical GCID transmission processing of a base station.

FIG. 7 is a flowchart for explanation of the processing content of the periodical GCID transmission processing, which is an interruption operation of the base station.

Regarding this processing, the femtocell base stations and macrocell base station are performing the same processing.

As shown in FIG. 7, the processing starts with step S710 which sets up a signal transmission timer, and proceeds to step S702 which renders the timer operative. At step S703, a decision is made as to whether or not the timer is expired. If the timer is not expired yet, then the procedure returns to the main processing of FIG. 6. If the timer is expired then send GCID at step S704. Thereafter, the procedure returns to the timer setting step S701 and then goes to step S702 which gets the timer started, followed by entry to the next cycle of processing.

Next, the processing content of PCID addition processing in the center machine 35 will be described below.

FIG. 8 is a flowchart for explanation of the processing content of the PCID addition processing in the center machine.

The center machine 35 receives from the newly added femtocell base station 21 a PCID application message which consists essentially of the PCID request, M-GCID of macrocell base station 11, F-GCID of the neighboring femtocell base station 23 (in some cases, this F-GCID is not contained as shown by S510 in FIG. 5) and F-GCID of femtocell base station 21 (at step S801). The center machine that has received the PCID application message performs a PCID addition authentication operation based on the GCID (S802). When the authentication is ended in fail, the center machine transmits an addition rejection message to the newly added femtocell base station.

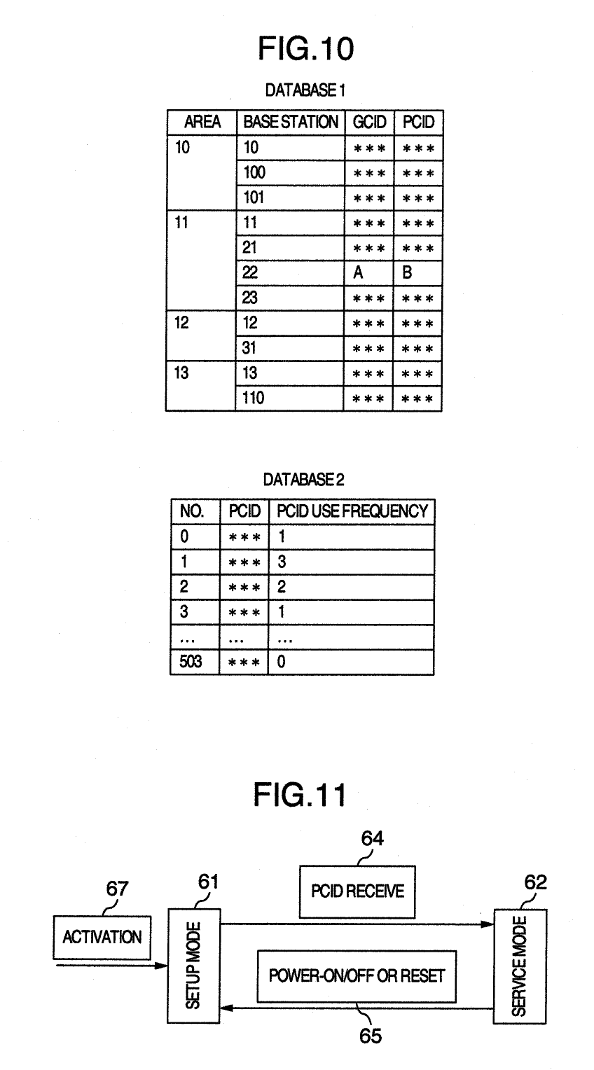

In case the authentication is completed successfully, the center machine specifies a land area of the newly added femtocell base station based on the M-GCID. (In the case of this embodiment, it is determinable by the M-GCID that the newly added femtocell base station 21 is presently within the area 11′.) In this embodiment, the center machine has its database as exemplarily shown in FIG. 10. The center machine searches the database of FIG. 10 (at step S804 of FIG. 8) and then determines those PCIDs being presently used within the area of the newly added femtocell base station (i.e., area 11′ in this example) and one or more unused or “idle” PCIDs therein. In the case of such unused PCIDs being found, the center machine selects any given PCID from among them and assigns it to the newly added femtocell base station (at S806). If no such unused PCIDs are found, the center machine selects one of the currently used PCIDs which is low in frequency of usage, and assigns the selected PCID to the newly added femtocell base station (at S807). Thereafter, the center machine transmits the PCID assigned to the newly added femtocell base station (S808).

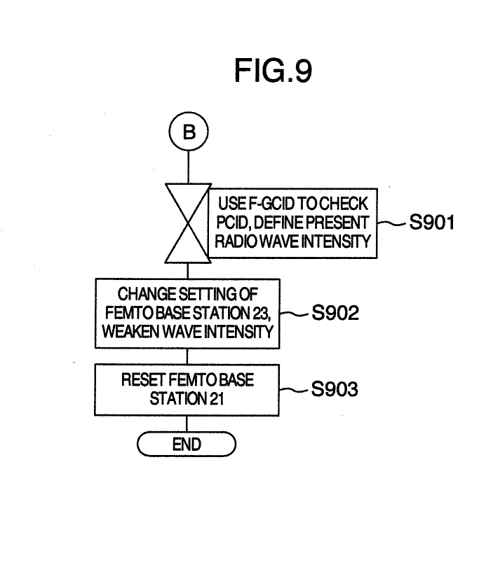

In case the center machine has also received the neighbor F-PCID at step S801, the procedure transits to the processing of “B” shown in FIG. 9. When the neighbor F-PCID is not received at step S801, the assignment processing is ended.

An explanation will next be given of processing for avoiding undesirable interference between the newly added femtocell base station and any one of the currently existing femtocell base stations.

FIG. 9 is a flowchart for explanation of the content of the processing to be executed by the center machine for eliminating mutual interference between femtocell base stations.

In case the PCID application message that was sent by the newly added femtocell base station 21 to the center machine 35 contains the GCID of the neighboring femtocell base station 23, the center machine checks, based on the received neighboring femtocell base station's GCID, the PCID of such neighboring femtocell base station and a present radio field intensity (at step S901). And, when it is necessary to weaken the radio field intensity of the neighboring femtocell base station 23, appropriate setting is done to weaken the radio field intensity of the neighboring femtocell base station (e.g., reduce it by 10%) (at S902). Thereafter, the center machine resets the added femtocell base station 21 (S903). After having reset it, the added femtocell base station 21 again transits to the setup mode, for executing the process flow shown in FIG. 8 to thereby send forth the PCID application message toward the center machine.

In case the PCID application message from the newly added femtocell base station 21 does not contain the information of a neighboring base station(s), the processing for eliminating interference between the newly added femtocell base station and its neighboring femtocell base station is ended. When the PCID application message that was sent after the resetting contains therein the information of such neighboring base station, the interference elimination processing is executed again for performing second-time adjustment, thereby forcing the neighboring femtocell base station to further decrease in wave field intensity by 10%, for example. By performing several automatic adjustments, the existing femtocell base station 23 is shrunk in radio wave coverage area from 223′ to 23′ as shown in FIG. 2. This makes it possible to eliminate or at least greatly mitigate the occurrence of interference against the newly added femtocell base station 21.

In a similar way, in case the newly added femtocell base station 21 interferes with its neighboring femtocell base station 23 also, the above-stated method is employable to enable avoidance of such interference.

In reality, the femtocell base station resetting accompanies equipment reconfiguration. In view of this, when coming under the interference of the neighboring femtocell base station, any base station to be reconfigured receives the GCID thereof without fail and reports it to the center machine 35.

FIG. 10 is a diagram showing an exemplary database arrangement in the center machine.

In the example shown in FIG. 10, a database 1 is arranged to store therein the information of macrocell base stations, femtocell base stations, and the information of GCIDs and PCIDs of these base stations on a per-area basis. The information of the currently existing base stations is such that system parameters are periodically searchable for updating the information when the need arises. Whenever a femtocell base station is newly added, the database 1 is updated so that a GCID is added thereto in every PCID application event.

Assuming in the example shown in FIG. 10 that the base stations 10, 11, 12 and 13 are macrocell base stations whereas base stations 100, 101, 21, 22, 23, 31 and 110 are femtocell base stations, there are four macrocell base stations and seven femtocell base stations, two of which femtocell base stations, i.e., femtocell base stations 100-101, are placed within the area of the macrocell base station 10. In the area of the macrocell base station 11, there are three femtocell base stations 21, 22 and 23. In the area of the macrocell base station 12, there is a single femtocell base stations 31. In the area of the macrocell base station 13, there is one femtocell base station 110.

The center machine also has a database 2 with the frequency of usage being recorded therein on a per-PCID basis. The center machine records in this table a value indicative of the frequency of usage of each PCID and looks up this table when adding a new PCID. The total number of PCIDs is 504 in the LTE standard as stated previously. The sequence order of PCIDs is recorded in a column named “No.”; in a PCID column, PCID values are retained; and, in a usage frequency column, use frequency values are held.

The center machine refers to these databases 1 and 2 and uses the method shown in FIG. 8 to assign a PCID to a femtocell base station which has sent a PCID application message.

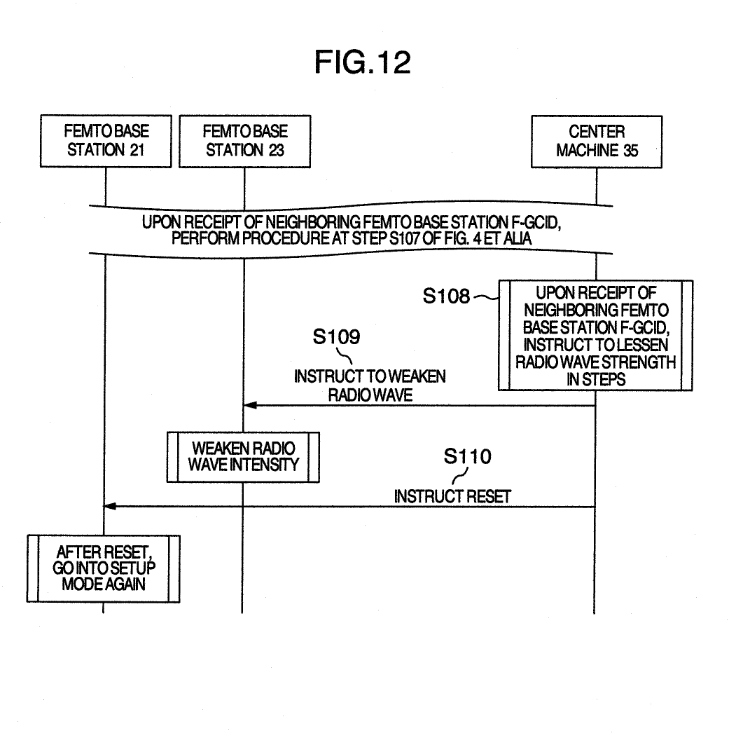

See FIG. 11, which is a state transition diagram of a femtocell base station.

Upon power-on, the femtocell base station is rendered operative (at state block 67); thereafter, it goes into the setup mode (61). When receiving a PCID in the setup mode (64), the base station transits to its service mode (62). The condition of letting it return to the setup mode from the service mode is based on whether electrical power is turned on/off or whether reset is done (65).

See FIG. 12, which shows a sequence for eliminating mutual interference between femtocell base stations.

FIG. 12 shows, in sequence diagram form, the processing for avoiding interference between femtocell base stations as has been explained in conjunction with FIG. 9. When the center machine receives the GCID of its neighboring femtocell base station which is contained in the PCID application message as sent from the newly added femtocell base station, the center machine transmits an instruction for forcing the neighboring femtocell base station to decrease in radio field intensity to thereby ensure that it does not interfere with the newly added femtocell base station; thereafter, the center machine instructs the added femtocell base station to perform a reset operation. After having completed the resetting, the center machine again receives the PCID application message from the added femtocell base station and then performs similar processing repeatedly until any neighboring femtocell base station's GCID is no longer contained in such message, thereby eliminating the interference between femtocell base stations.

It should be further understood by those skilled in the art that although the foregoing description has been made on embodiments of the invention, the invention is not limited thereto and various changes and modifications may be made without departing from the spirit of the invention and the scope of the appended claims.

1. A wireless communication system including a plurality of macrocell base stations, a plurality of femtocell base stations, a center machine operatively connected via a network to said plurality of macrocell base stations and said plurality of femtocell base stations, and each of said macrocell base stations and said femtocell base stations being managed with addition of a globally unique global cell identity (GCID) and one of a limited number of physical-layer cell identities (PCIDs) for allowing a wireless terminal to identify a radio signal to be sent from a base station, wherein
said limited number of PCIDs are divided in advance into a group of PCIDs to be added to macrocell base stations and a group of PCIDs to be added to femtocell base stations,
said center machine has a first table storing therein area information of a plurality of macrocell base stations and femtocell base stations within said wireless communication system along with said GCID and said PCIDs, and a second table retailing information as to usage states of said limited number of PCIDs within said wireless communication system,
a femtocell base station attempting to apply for addition of a PCID transmits to said center machine a PCID addition application message containing therein a GCID of a macrocell base station adjacent to the femtocell base station, a GCID of this femtocell base station, and a GCID of a radio wave-receivable neighboring femtocell base station, if any, and
upon receipt of the PCID addition application message, said center machine refers to the first table to thereby identify an area of the message-transmitted femtocell base station and one or more PCIDs being presently used in this area, selects an unused PCID in said area, and sends it to said femtocell base station.

2. The wireless communication system according to claim 1, wherein in a case where the unused PCID is absent within the area, said center machine refers to said second table to thereby select a PCID which is low in frequency of usage, and then sends it to said femtocell base station.

3. The wireless communication system according to claim 1, wherein in a case where the GCID of the neighboring femtocell base station is included in said PCID addition application message, said center machine sends to the neighboring femtocell base station an instruction message for reducing a radio field intensity by a predefined constant amount.

4. The wireless communication system according to claim 2, wherein in a case where the GCID of the neighboring femtocell base station is included in said PCID addition application message, said center machine sends to the neighboring femtocell base station an instruction message for reducing a radio field intensity by a predefined constant amount.

5. The wireless communication system according to claim 3, wherein after having sent to the neighboring femtocell base station the instruction message for reducing the radio field intensity, said center machine sends a reset instruction message to the femtocell base station which has sent said PCID addition application message, and permits this femtocell base station to perform again detection of its neighboring femtocell base stations and transmission of the PCID addition application message.

6. A physical-layer cell identity (PCID) assignment method for use in a wireless communication system including a plurality of macrocell base stations, a plurality of femtocell base stations, a center machine operatively connected via a network to said plurality of macrocell base stations and said plurality of femtocell base stations, and each of said macrocell base stations and said femtocell base stations being managed with addition of a globally unique global cell identity (GCID) and one of a limited number of physical-layer cell identities (PCIDs) for allowing a wireless terminal to identify a radio signal to be sent from a base station, wherein
a femtocell base station attempting to apply for addition of a PCID transmits to said center machine a PCID addition application message containing therein a GCID of a macrocell base station adjacent to the femtocell base station, a GCID of this femtocell base station, and a GCID of a radio wave-receivable neighboring femtocell base station, if any, and
upon receipt of the PCID addition application message, said center machine refers to a first table storing therein area information of a plurality of macrocell base stations and femtocell base stations within said wireless communication system and said GCID plus said PCIDs to thereby identify an area of the femtocell base station which has sent the message and one or more PCIDs being presently used in this area, selects an unused PCID in said area, and then sends it to said femtocell base station.

7. The PCID assignment method according to claim 6, wherein in a case where the unused PCID is absent within the area, said center machine refers to a second table retaining information as to usage states of said limited number of PCIDs in said wireless communication system to thereby select a PCID which is low in frequency of usage and then sends it to said femtocell base station.

8. The PCID assignment method according to claim 6, wherein when the GCID of the neighboring femtocell base station is included in said PCID addition application message, said center machine sends to the neighboring femtocell base station an instruction message for reducing a radio field intensity by a predefined constant amount.

9. The PCID assignment method according to claim 7, wherein when the GCID of the neighboring femtocell base station is included in said PCID addition application message, said center machine sends to the neighboring femtocell base station an instruction message for reducing a radio field intensity by a predefined constant amount.

10. The PCID assignment method according to claim 8, wherein after having sent to the neighboring femtocell base station the instruction message for reducing the radio field intensity, said center machine sends a reset instruction message to the femtocell base station which has sent said PCID addition application message, and permits this femtocell base station to perform again detection of its neighboring femtocell base stations and transmission of the PCID addition application message.
